(19) United States
(12) Patent Application Publication
(10) Pub. No.: US 2008/0233426 A1
(43) Pub. Date: Sep. 25, 2008

(54) Steel sheeting for use in room size radio frequency shielded enclosures and method for making improved steel sheeting

(76) Inventor: John J. Gaviglia, Glenshaw, PA (US)

Correspondence Address: MEYER UNKOVIC & SCOTT LLP, 1300 OLIVER BUILDING, PITTSBURGH, PA, 15222, US

(21) Appl. No.: 12/075,902

(22) Filed: Mar. 14, 2008

Related U.S. Application Data
(60) Provisional application No. 60/896,153, filed on Mar. 21, 2007.

(51) Int. Cl. B32B 15/01; B05D 7/14; B23K 1/20

(52) U.S. Cl. 428/648; 427/127; 228/203

(57) ABSTRACT

A radio-frequency shield comprised of a sheet of steel and tin-plating on at least one side of said sheet of steel. In addition, a method of making a radio-frequency shielding consisting of tin-plating at least one side of at least one sheet of steel. In addition, a backer material can be added to the back side the steel sheet which allows tin-plated steel sheets to be overlayed and attached to one another.

### PRIORITY

This application hereby claims priority to provisional patent application Ser. No. 60/896,153, filed on Mar. 21, 2007.

### FIELD OF THE INVENTION

The invention is generally related to an improved steel sheeting for use in room size radio frequency shielded enclosures and a method for making improved steel sheeting. In particular, the invention uses tin plated steel sheet of varying thicknesses which are continuously soldered together at the seams to provide the means to construct a Radio Frequency (“RF”) Shielded enclosure.

### BACKGROUND OF THE INVENTION

There exists a current need for RF shielding in connection with various needs, including medical and government applications. Specifically, where magnetic resonance imaging (“MRI”) is used in medical applications, it is important to screen and shield external radio frequencies from the room in which MRI procedures are conducted. In addition, in some applications, it is also important to shield the room from external magnetic fields as well. Similar concerns arise in government and military applications where it is also desired to shield against radio frequencies and magnetic fields.

Electromagnetic shielding is the process of limiting the flow of electromagnetic fields between two locations, by separating them with a barrier made of conductive material. Typically it is applied to enclosures, separating electrical devices from the ‘outside world’. Electromagnetic shielding used to block radiofrequency electromagnetic radiation is also known as RF shielding.

RF shielding can reduce the coupling of radio waves, electromagnetic fields and electrostatic fields, though not static or low-frequency magnetic fields. (A conductive enclosure used to block electrostatic fields is also known as a Faraday cage.) The amount of reduction depends very much upon the material used, its thickness, and the frequency of the fields of interest. Typical materials used for electromagnetic shielding include sheet metal, metal mesh, ionized gas, and plasma. Any holes in the shield or mesh must be significantly smaller than the wavelength of the radiation that is being kept out, or the enclosure will not effectively approximate an unbroken conducting surface.

Electromagnetic radiation consists of coupled electric and magnetic fields. The electric field produces forces on the charge carriers (i.e., electrons) within the conductor. As soon as an electric field is applied to the surface of an ideal conductor, it generates a current that causes displacement of charge inside the conductor that cancels the applied field inside, at which point the current stops.

Similarly, varying magnetic fields generate current vortices that act to cancel the applied magnetic field. (The conductor does not respond to static magnetic fields, so static magnetic fields can penetrate the conductor freely.) The result is that electromagnetic radiation is reflected from the surface of the conductor: internal fields stay inside, and external fields stay outside.

Several factors serve to limit the shielding capability of real RF shields. One is that, due to the electrical resistance of the conductor, the excited field does not completely cancel the incident field. Also, most conductors exhibit a ferromagnetic response to low-frequency magnetic fields, so that such fields are not fully attenuated by the conductor. Any holes in the shield force current to flow around them, so that fields passing through the holes do not excite opposing electromagnetic fields. These effects reduce the field-reflecting capability of the shield.

Currently, RF shielded enclosures are constructed using the following methods:
Method One—Galvanized sheet metal panels (having a gauge range of 11 to 32 and, preferably 24-28) are laminated to both sides of ¾″ thick plywood or particle board. The panels are then clamped together along their edges using galvanized steel shapes to typically construct a six sided enclosure. The ferrous galvanized steel also provides shielding to magnetic fields. These rooms are typically warranted for a period of one year.
Method Two—Copper or aluminum sheets of various thicknesses are applied to an existing structure of wood or steel studs on the floor, walls and ceiling and the seams are joined by using a conductive tape made of the same base material.
Method Three—Copper foil sheets reinforced with a paper or synthetic backing are wrapped around a wood frame and these frames are mechanically fastened together.
Method Four—Steel sheets or plates of various thicknesses are applied to a wood or steel structure on the floor, walls and ceiling and all seams are continuously welded together.
Method Five—Copper sheets of various thicknesses are applied to an existing structure of wood or steel studs on the floor, walls and ceiling and the seams are continuously soldered together.

These existing methods for providing RF shielding each have disadvantages as described below:
Method One—In this method, the galvanized sheet metal-lined wood panels are joined together by using galvanized steel shapes to clamp the edges together and create the electrical bond between the sheets. Over time, this clamping force is reduced by the relaxation of the clamping members and the compression of the wood panels. The joints are also subject to corrosion when moisture is present reducing the conductivity across the joints.
Method Two—This method is not commonly used in permanent structures such as MRI Equipment rooms and Calibration labs because of the useful life of the tape. As the mastic on the tape ages and dries, it begins to loose it adherence to the sheet metal and conductivity decreases across the joint in a relatively short period of time. This method also offers little shielding from magnetically generated fields. Rooms constructed with this method normally carry no warranty period and are used primarily as temporary or short term use structures.
Method Three—This method, which uses reinforced copper foil sheet wrapped around a prefabricated wood frame, again requires a clamping force created by metal fasteners along the edges of the panels to create the electrical connection between the prefabricated panels. These joints are susceptible to corrosion in the presence of moisture, reducing the conductivity across the joints. This method also offers little shielding from magnetically generated fields. The foil is also more susceptible to physical damage and tearing than the other methods.
Method Four—This method employs welded steel sheet or plate. The type of enclosure resulting from this method is normally used where not only RF shielding and magnetic shielding are required but physical security is also needed. Since the joints are welded, there is no degradation in conductivity at the joints with time or the presence of moisture. Because of the costs in erecting this type of enclosure, however, it is normally limited to installations in military or government facilities. Electric field and magnetic field attenuation performance levels are higher in this type of enclosure than in methods one, two or three. Magnetic field attenuation characteristics are higher than in method five.
Method Five—This method, which uses copper sheet with all the seams soldered together, has many advantages over the preceding four methods. The copper sheet is thicker than the foil used in method three, creating a shield that is less susceptible to physical damage. Also, soldered joints offer a lifetime of performance compared to joints that are taped together. Method five is considerably more flexible in its ability to contour to the parent room's shape than the prefabricated panels in methods one, three and four. Further, method five's soldered joints offer a lifetime of performance compared to mechanically fastened joints. In comparison to method four, in particular, since all seams are continuously soldered together in method five to create the electrical connection between each sheet, there is no degradation in conductivity at the joints with time or the presence of moisture or even standing water. Costs are also substantially less in method five and compared to method four.

However, since copper is non-ferrous, a method five type of enclosure has little shielding to magnetically generated fields. In addition, this the costs associated with this method rise and fall with the costs of copper.

Accordingly, a need exists for an improved method of RF shielding that has a low cost and is also suitable for shielding of magnetically generated fields.

### SUMMARY OF THE INVENTION

An object of the present invention is to provide an improved method of RF shielding that has a low cost and is also suitable for shielding of magnetically generated fields. Specifically, the present invention uses tin-plated sheets of various thicknesses that are applied to an existing structure of wood or steel studs on the floor, walls and ceiling. The tin-plated steel sheet are continuously soldered together at the seams to provide the means to construct a Radio Frequency (“RF”) Shielded enclosure that also provides shielding against magnetically generated fields.

### BRIEF DESCRIPTION OF THE FIGURES

FIG. 1 is a side perspective view showing the relation of the tin-plating, the steel sheet and the backer material of the present invention.

FIG. 2 discloses a perspective view of two tin-plated steel sheets of the present invention on a backer material, with the sheets aligned and overlapped at the point of soldering.

### DETAILED DESCRIPTION OF THE INVENTION

The invention will now be described in detail in relation to a preferred embodiment and implementation thereof which is exemplary in nature and descriptively specific as disclosed. As is customary, it will be understood that no limitation of the scope of the invention is thereby intended. The invention encompasses such alterations and further modifications in the illustrated apparatus, and such further applications of the principles of the invention illustrated herein, as would normally occur to persons skilled in the art to which the invention relates.

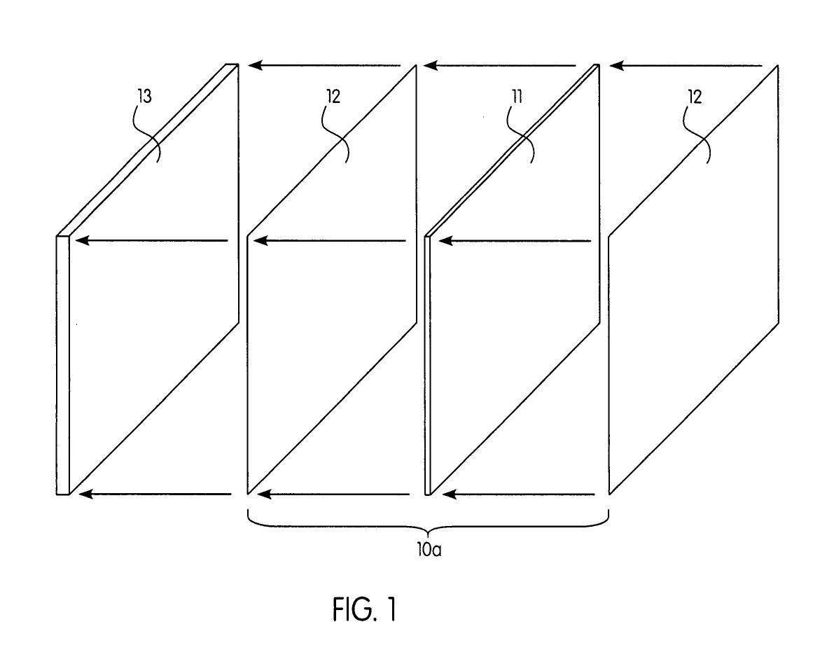

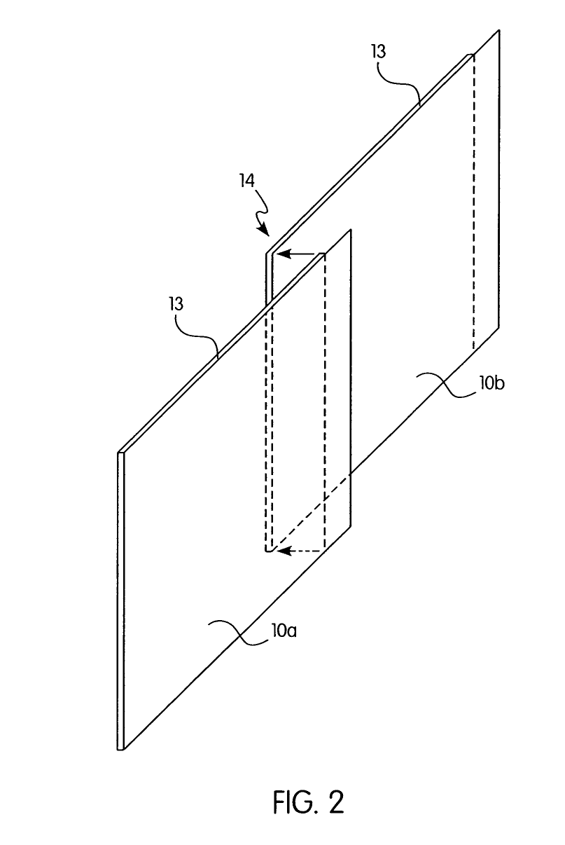

And now, referring to FIGS. 1 and 2, two tin-plated steel sheets 10a and 10b of the present invention are disclosed. The tin-plated steel sheets 10a and 10b are comprised of a steel sheet 11 and tin-plating 12 preferably located on both sides of sheet 11 (although it may be located on just one side). Steel sheet 11 can be of varying thicknesses, but preferably has a thickness in the range of about 0.010-0.120 inches. Similarly, the tin-plating 12 can also have varying thicknesses based upon manufacturing processes. The steel sheet 11 can be comprised of low carbon steel or silicon steel, as well as other steels that provide for better magnetic performance.

Each tin-plated steel sheet 10a and 10b is preferably positioned on a backer material 13 that can be of varying thicknesses and fire ratings and is typically constructed from wood, although other materials can also be used. Alternatively, no backer material may be used. The backer material 13 provides support for the tin-plated steel sheets 10a and 10b. Backer 13 is preferably attached to the tin-plated steel sheets 10a and 10b by an adhesive or glue, including, without limitation, contact cement or neoprene.

The tin-steel steel sheets 10a and 10b are aligned and overlapped at the point of soldering 14. At the point of overlap 14, no backer material is used so that one tin-plated steel sheet 10a can be directly soldered to a second tin-plated steel sheet 10b. This process can continue to allow for joinder of several sheets. The width of the overlap area 14 that is soldered can vary, but is preferably in a range of about ½ inch to 1 inch. Any alloy-based solder can be used, including, without limitation, lead-based or tin-based solder. This process is repeated, as necessary, using sheets of needed sizes and shapes to create a shielded enclosure.

The present invention differs from and improves upon the prior methods in the present invention's use of tin-plated steel sheet of various thicknesses. In particular, tin-plated sheet and the related method of creating shielded enclosures using tin-plated metal sheeting provides all of the benefits of method five, described above, including flexibility, resistance to physical damage, and lifetime performance, but with lower costs and enhanced magnetic fields. This present invention allows provides the enhanced attenuation to magnetic fields provided by methods one and four, but again with lower costs as compared to method four and more resistance to physical damage as compared to method one.

Currently, where enhanced magnetic shielding is needed in existing methods (where possible), either a layer or layers of steel sheet is installed behind the copper sheet in methods three or five, or thicker layers of galvanized sheet metal are used in method 1 to enhance magnetic shielding performance in these methods. However, none of the existing methods offer the combination of lifetime performance, enhanced magnetic shielding performance and cost performance as with the present invention. Indeed, despite a long felt need for an RF shielding combining these desired properties, no such shielding method existed prior to the present invention.

1. A radio-frequency shield comprised of a sheet of steel and tin-plating on at least one side of said sheet of steel.

2. The shield according to claim 1, where said steel sheet has a thickness of about 0.010-0.120 inches.

3. The shield according to claim 1, wherein said steel is selected from the group consisting of low carbon steel or silicon steel.

4. The shield according to claim 1, wherein said steel has magnetic properties.

5. The shield according to claim 1, wherein said shield further comprises a backer material attached to one side of said steel sheet.

6. A method of making a radio-frequency shielding consisting tin-plating at least one side of at least one sheet of steel.

7. The method according to claim 6, where said steel sheet has a thickness of about 0.010-0.120 inches.

8. The method according to claim 6, wherein said steel is selected from the group consisting of low carbon steel and silicon steel.

9. The method according to claim 6, wherein said steel has magnetic properties.

10. The method according to claim 6, wherein said method further consists of the step of attaching a backer material to one side of said steel sheet.

11. The method according to claim 10, wherein said method further consists of the step of joining two or more of said tin-plated sheets of steel together, said joining process consisting of overlapping the edge of a first tin-plated steel sheet, said edge not having backer material, with the edge of a second tin-plated steel sheet, and soldering said edges together.

12. The method according to claim 11, wherein the width of said overlap is about ½ inch to 1 inch.

13. The method according to claim 11, wherein said soldering uses an alloy-based solder selected from the group consisting of lead-based and tin-based solder.
